(19) United States
(12) Patent Application Publication
(10) Pub. No.: US 2026/0322010 A1
(43) Pub. Date: Oct. 15, 2026

(54) CONNECTOR

(71) Applicant: BIZLINK INTERNATIONAL CORP., New Taipei City (TW)

(72) Inventors: Yung-Cheng LIN, New Taipei City (TW); Yi-Chen YANG, New Taipei City (TW); Yao-Han CHU, New Taipei City (TW)

(21) Appl. No.: 19/646,623

(22) Filed: Apr. 14, 2026

(30) Foreign Application Priority Data
Apr. 14, 2025 (TW) 114203676

(51) Int. Cl. H01R 12/73; H01R 13/6597

(52) U.S. Cl. CPC H01R 12/73; H01R 13/6597

(57) ABSTRACT

The present disclosure relates to a connector, for installation on a printed circuit board. The connector includes a housing, an insulating, two terminal sets, and a shielding element. The insulating base is mounted within the housing and includes an insertion slot facing the printed circuit board. The two terminal sets are mounted within the housing and respectively positioned on opposite sides of the insulating base. The shielding element is mounted within the insertion slot. The shielding element has a contact end. The contact end is configured to make electrical contact with at least one of the two terminal sets.

### CROSS-REFERENCE TO RELATED APPLICATION

This application claims priority to Taiwan Application Serial Number 114203676, filed Apr. 14, 2025, which is herein incorporated by reference in its entirety.

### BACKGROUND

### Field of Invention

The present disclosure relates to a connector. More particularly, the present disclosure relates to a high-speed board-to-board connector for printed circuit boards.

### Description of Related Art

High-speed connectors currently available on the market for inter-server connections can be categorized into cable-end connectors and board-end connectors based on their connection methods. Cable-end connectors are typically mated with board-end connectors and are widely used in consumer electronics, telecommunications, industrial control, and data centers. Such high-speed connectors must not only meet the requirements for high-speed signal transmission and high-frequency design but also ensure mechanical durability, low insertion loss, and good electromagnetic compatibility (EMC).

As a critical component of connectors, shielding plates primarily serve to suppress electromagnetic interference, ensuring that signals remain unaffected by external noise during transmission and preventing internal high-frequency signals from radiating outward. With the continuous advancement of modern electronic technology, these technical considerations and design requirements are constantly evolving to meet ever-higher performance standards.

### SUMMARY

The present disclosure relates to a connector, for installation on a printed circuit board. The connector includes a housing, an insulating base, two terminal sets, and a shielding element. The insulating base is mounted within the housing and includes an insertion slot facing the printed circuit board. The two terminal sets are mounted within the housing and respectively positioned on opposite sides of the insulating base. The shielding element is mounted within the insertion slot. The shielding element has a contact end. The contact end is configured to make electrical contact with at least one of the two terminal sets.

The present disclosure also relates to a connector, for installation on a printed circuit board. The connector includes a housing, an insulating base, two terminal sets, and a shielding element. The insulating base is mounted within the housing and includes an insertion slot. The insertion slot has an opening facing the printed circuit board. The two terminal sets are mounted within the housing and respectively positioned on opposite sides of the insulating base. The shielding element is mounted within the insertion slot. The shielding element has a contact end. The contact end is configured to make electrical contact with one of the two terminal sets.

In summary, the connector of the present disclosure facilitates the quick and easy installation of the shielding element between two terminal sets by providing the insertion slot in the insulating base with the opening facing the printed circuit board. Furthermore, since the shielding element of the connector of the present disclosure contacts only one of the terminal sets on a single side, it simplifies the assembly process and reduces the production cost of the shielding element while meeting standard shielding specifications.

It is to be understood that both the foregoing general description and the following detailed description are by examples, and are intended to provide further explanation of the present disclosure as claimed.

### BRIEF DESCRIPTION OF THE DRAWINGS

The present disclosure can be more fully understood by reading the following detailed description of the embodiment, with reference made to the accompanying drawings as follows:

FIG. 1 is a schematic view of a connector according to an embodiment of the present disclosure;

FIG. 2 is an exploded view of the connector according to an embodiment of the present disclosure;

FIGS. 3A and 3B are schematic views of an insulating base according to an embodiment of the present disclosure;

FIGS. 4A and 4B are alternative schematic views of the insulating base according to an embodiment of the present disclosure;

FIG. 5A is a schematic view of a first terminal set according to an embodiment of the present disclosure;

FIG. 5B is a schematic view of a second terminal set according to an embodiment of the present disclosure;

FIG. 6 is a cross-sectional view of partial components of the connector according to an embodiment of the present disclosure; and

FIG. 7 is another schematic view of partial components of the connector according to an embodiment of the present disclosure.

### DETAILED DESCRIPTION

Reference will now be made in detail to the present embodiments of the present disclosure, examples of which are illustrated in the accompanying drawings. Wherever possible, the same reference numbers are used in the drawings and the description to refer to the same or like parts.

The following description provides numerous different embodiments or examples for implementing various features of the subject matter disclosed herein. The following description of specific examples of components and arrangements is provided to simplify the present disclosure. Of course, these are merely examples and are not intended to be limiting. Furthermore, the present disclosure may repeat component symbols and/or letters in various examples. Such repetition is for the purposes of simplification and clarity and does not in itself indicate any relationship between the various embodiments and/or configurations described.

In addition, the drawings of the present disclosure are drawn to actual scale. To keep the description concise, the proportions of each component are not listed individually. However, the proportions and positions of each component should be considered part of this description. The following provides a detailed explanation of the structure, function, and interconnections of the various components included in a connector BC of embodiments of the present disclosure.

To enable the reader to clearly understand the relative positions and orientations of the various components, the drawings include coordinate axes: a first axis A1, a second axis A2, and a third axis A3.

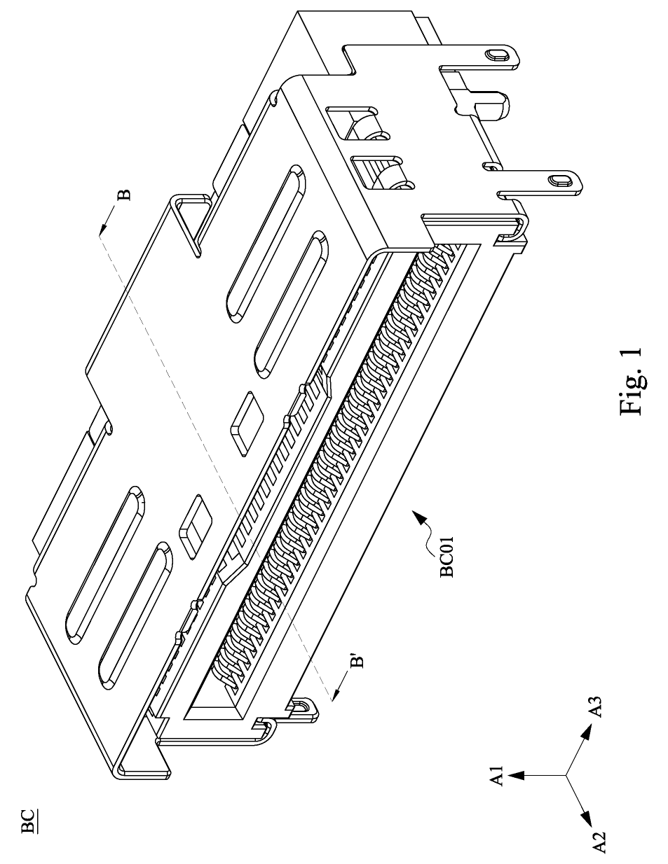

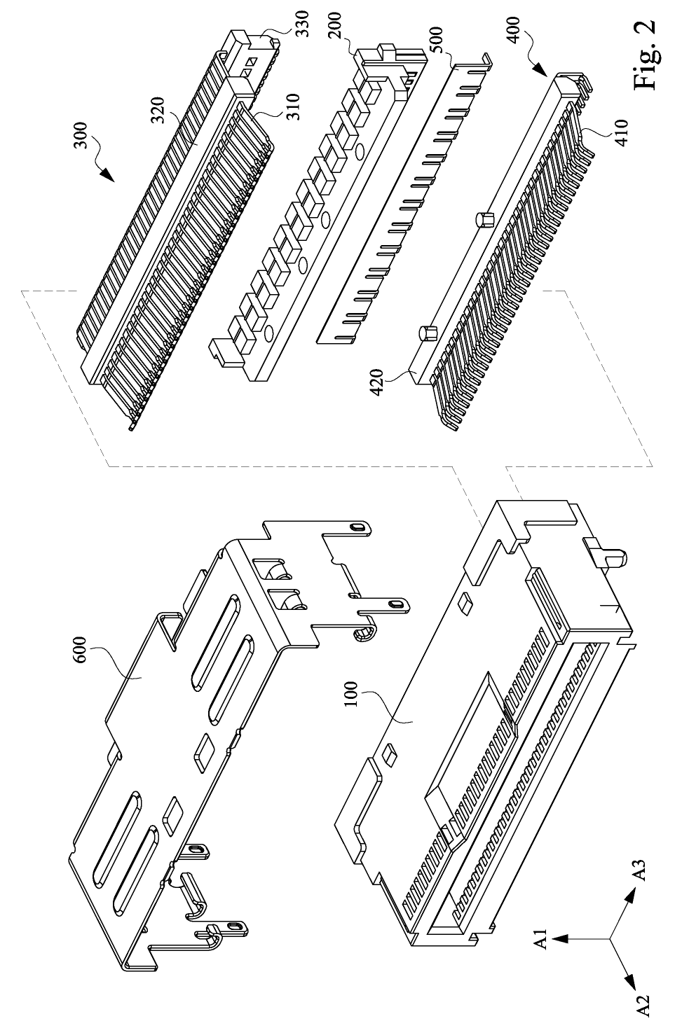

Please refer to FIGS. 1 and 2. FIGS. 1 and 2 show a schematic view and an exploded view of the connector BC of the present disclosure, respectively. In some embodiments, the connector BC is a high-speed connector, such as a board-to-board connector, primarily mounted on a printed circuit board (PCB) to connect two PCBs vertically or in parallel, thereby supporting high-speed signal transmission. In FIG. 1, a mounting side BC01 at the bottom of the connector BC is a side facing the PCB during installation.

In some embodiments, the connector BC includes a shell 600, a housing 100, an insulating base 200, a first terminal set 300, a second terminal set 400, and a shielding element 500. The insulating base 200, the first terminal set 300, and the second terminal set 400 are mounted within the housing 100. The shielding element 500 is mounted within the insulating base 200. The shell 600 partially encloses the housing 100. The first terminal set 300 and the second terminal set 400 include first signal terminals, second signal terminals, and ground terminals, respectively.

In some embodiments, the first terminal set 300 includes a plurality of equidistantly arranged first terminals 310, a first insulating module 320 for supporting and securing the terminals, and a third insulating module 330. The second terminal set 400 includes a plurality of equidistantly arranged second terminals 410 and a second insulating module 420 for supporting and securing the terminals.

In some embodiments, the insulating base 200, the first insulating module 320, the second insulating module 420, and the third insulating module 330 are made of insulating materials, such as plastics like LCP (liquid crystal polymer) or PBT (polybutylene terephthalate) that are resistant to high temperatures and high voltage. However, the present disclosure is not limited thereto.

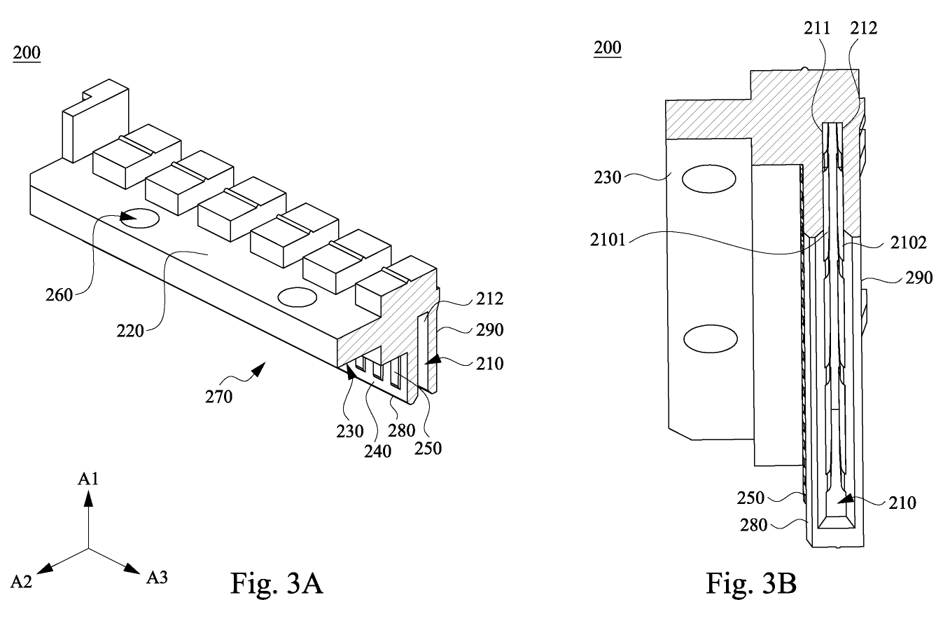

Please refer to FIGS. 3A and 3B. FIGS. 3A and 3B are schematic views of the insulating base 200 from different angles. In some embodiments, the insulating base 200 includes an insertion slot 210, a first surface 220, a second surface 230, an abutting surface 240, at least one abutting rib 250 located on the abutting surface 240, at least one through-hole 260 extending through the first surface 220 and the second surface 230, a bottom 270 adjacent to a printed circuit board during installation, and a third surface 290.

The first surface 220 is opposite the second surface 230, and the abutting surface 240 is opposite the third surface 290. A direction of extension of the first surface 220 and the second surface 230 is perpendicular to a direction of extension of the abutting surface 240 and the third surface 290. A side of the insulating base 200 generally has an L-shaped structure. An outer side of the L-shaped structure includes the first surface 220 and the third surface 290, while an inner side of the L-shape structure includes the second surface 230 and the abutting surface 240. The first surface 220 and the third surface 290 are respectively used to contact the first terminal set 300. The second surface 230 and the abutting surface 240 respectively contact the second terminal set 400.

In some embodiments, the insertion slot 210 is located on the bottom 270, and the opening of the insertion slot 210 faces the printed circuit board. The insertion slot 210 is configured for mounting the shielding element 500. Positioning the opening of the insertion slot 210 to face the printed circuit board (i.e., locating the opening on the bottom 270) facilitates the insertion of the shielding element 500 during assembly.

In some embodiments, the insulating base 200 further includes at least two engaging ribs 2101, 2102 located within the insertion slot 210, configured to secure the shielding element 500. A number of engaging ribs may be adjusted as needed to accommodate the length of the insulating base 200. In FIG. 3B, the insertion slot 210 includes a first inner side wall 211 and a second inner side wall 212. The engaging ribs 2101 and 2102 are located on the first inner side wall 211 and the second inner side wall 212, respectively, and arranged in pairs at positions opposite each other on the first inner side wall 211 and the second inner side wall 212. In other words, the engaging ribs 2101 and 2102 are arranged symmetrically with respect to each other within the insertion slot 210.

In some embodiments, the insulating base 200 may include multiple abutting ribs 250 configured to receive the second terminal 410. Specifically, the spacing and positioning of the abutting ribs 250 relative to one another are arranged to correspond to the second terminal 410. In FIG. 3A, the insulating base 200 further includes a long side 280 located at the bottom 270, wherein the multiple abutting ribs 250 are arranged in parallel along the direction of alignment of the first surface 220 and the second surface 230 (i.e., along the first axis A1) and are spaced apart from one another along the extension of the long side 280.

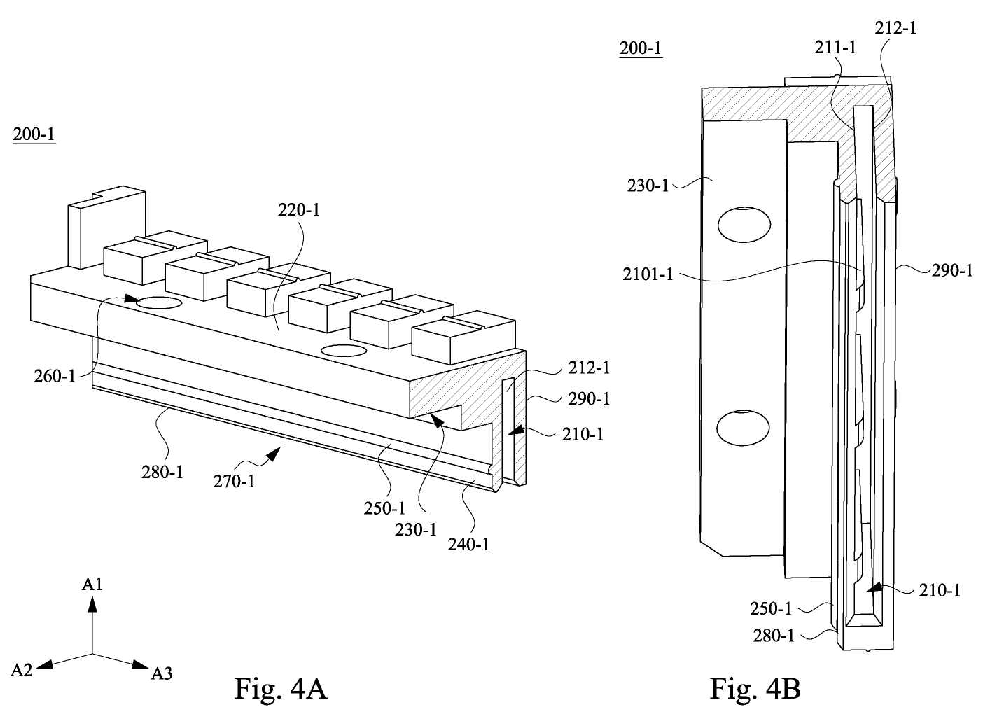

Please refer to FIGS. 4A and 4B. FIGS. 4A and 4B are schematic views of an insulating base 200-1 of another embodiment. In some embodiments, the insulating base 200-1 includes an insertion slot 210-1, a first surface 220-1, a second surface 230-1, an abutting surface 240-1, an abutting rib 250-1, at least one through-hole 260-1, a bottom 270-1, and a third surface 290-1. The insertion slot 210-1 includes a first inner side wall 211-1 and a second inner side wall 212-1.

Compared to the embodiment of the insulating base 200 described above, the insulating base 200-1 shown in FIGS. 4A and 4B differs in that the abutting surface 240-1 has only one abutting rib 250-1. The abutting rib 250-1 extends along the long side 280-1 of the abutting surface 240-1 to span the abutting surface 240-1. In other words, the abutting rib 250-1 extends across the abutting surface 240-1 in a direction perpendicular to the arrangement of the first surface 220-1 and the second surface 230-1 (i.e., along the third axis A3).

Another feature of the insulating base 200-1 is that the engaging rib 2101-1 may be located only on one of the inner side walls of the insertion slot. In FIG. 4B, the engaging rib 2101-1 is located on the first inner side wall 211 of the insertion slot 210, which is adjacent to the abutting surface 240. Multiple engaging ribs 2101-1 may be arranged at equal distances from one another. In other embodiments, the engaging rib 2101-1 may be located only on the second inner side wall 212.

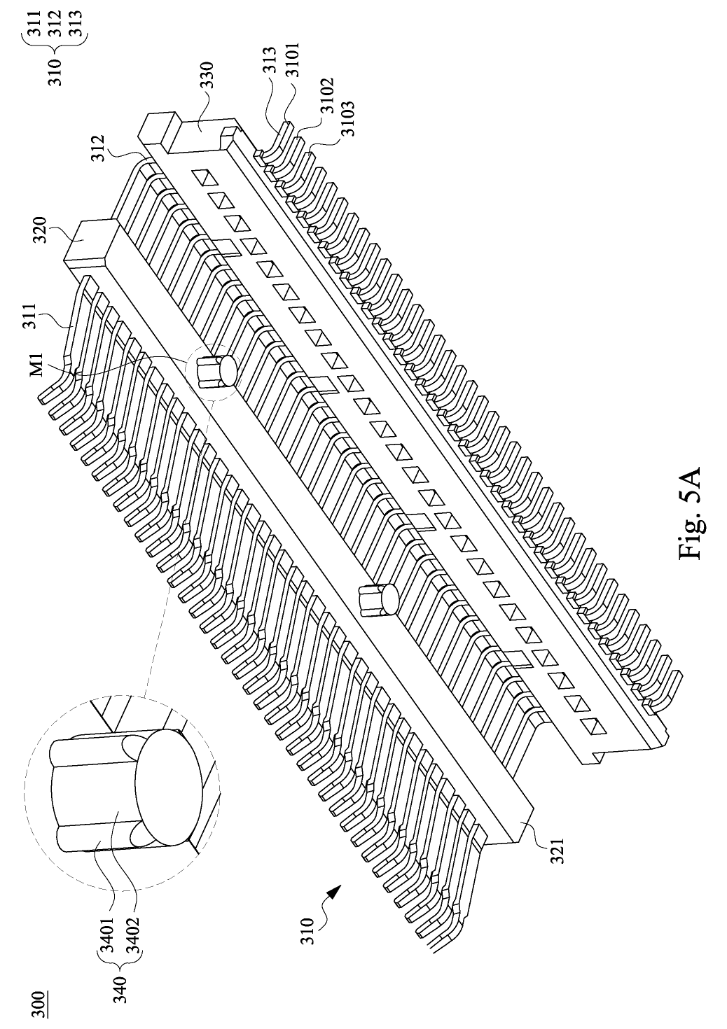

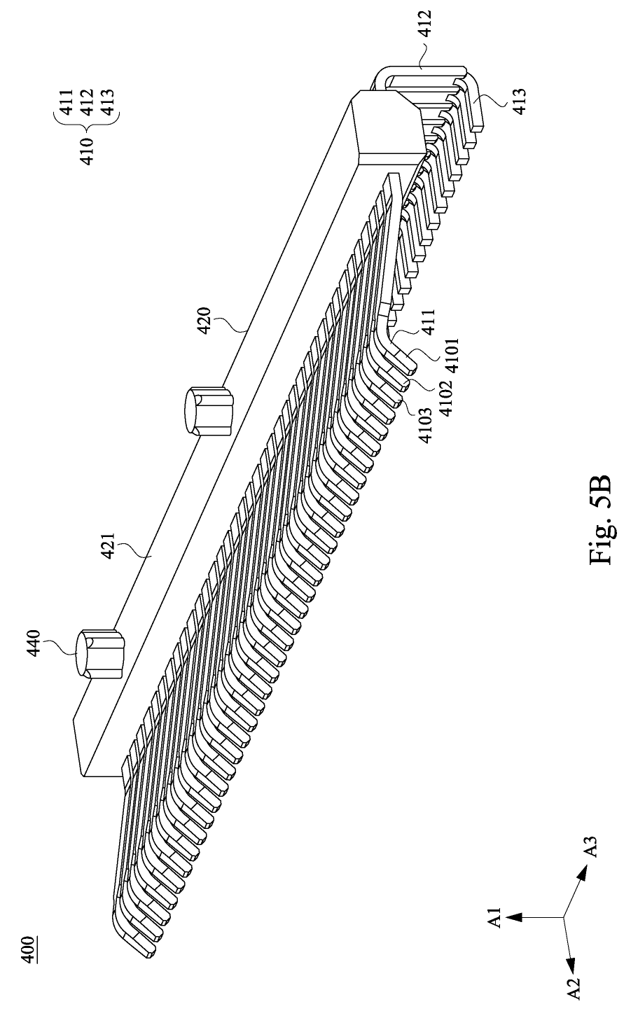

Please refer to FIG. 5A. FIG. 5A is a schematic view of the first terminal set 300. In some embodiments, the first terminals 310 are arranged in groups of three, repeated in the order of ground terminal 3101, signal terminal 3102, and signal terminal 3103.

In some embodiments, each first terminal 310 includes a front end 311, a middle end 312, and a rear end 313. The middle end 312 is approximately perpendicular to the front end 311 and the rear end 313, and is connected to the front end 311 and the rear end 313 at its respective ends. The front end 311 and the rear end 313 extend in opposite directions from the middle end 312. The front end 311 is configured to contact other connecting elements. The first terminal 310 is secured to the first insulating module 320 via the front end 311 and to the third insulating module 330 via the middle end 312. The rear end 313 is configured to contact the shielding element 500.

In some embodiments, the first insulating module 320 includes a first contact surface 321 that contacts the insulating base 200, and a first engaging structure 340 located on the first contact surface 321. A number of first engaging structures 340 may be adjusted as needed, and their arrangement and spacing are not limited, provided they can mate with the through-hole 260 of the insulating base 200.

In the enlarged view enclosed by dashed line M1 in FIG. 5A, the first engaging structure 340 includes a body 3401 and an engaging flange 3402 located on an outer periphery of the body 3401. The first engaging structure 340 is configured to be locked into the through-hole 260 of the insulating base 200. The design of the engaging flange 3402 ensures that the structure of engagement is more securely fastened.

Please refer to FIG. 5B. FIG. 5B is a schematic view of the second terminal set 400. In some embodiments, the second terminals 410 are arranged in groups of three, repeated in the order of ground terminal 4101, signal terminal 4102, and signal terminal 4103.

In some embodiments, each second terminal 410 includes a front end 411, a middle end 412, and a rear end 413. The middle end 412 is approximately perpendicular to the front end 411 and the rear end 413, and is connected to the front end 411 and the rear end 413 at its respective ends. The front end 411 and the rear end 413 extend in the same direction from the middle end 412. The front end 411 is configured to contact other connecting elements, and the second terminal 410 is secured to the second insulating module 420 via the front end 411. The middle end 412 is configured to abut against the abutting ribs 250, 250-1 of the insulating base 200. The rear end 413 is configured to contact the shielding element 500.

In some embodiments, the second insulating module 420 includes a second contact surface 421 that contacts the insulating base 200, as well as a second engaging structure 440 located on the second contact surface 421. The second engaging structure 440 shares the same construction and design concept as the first engaging structure 340 described above and will not be repeated here.

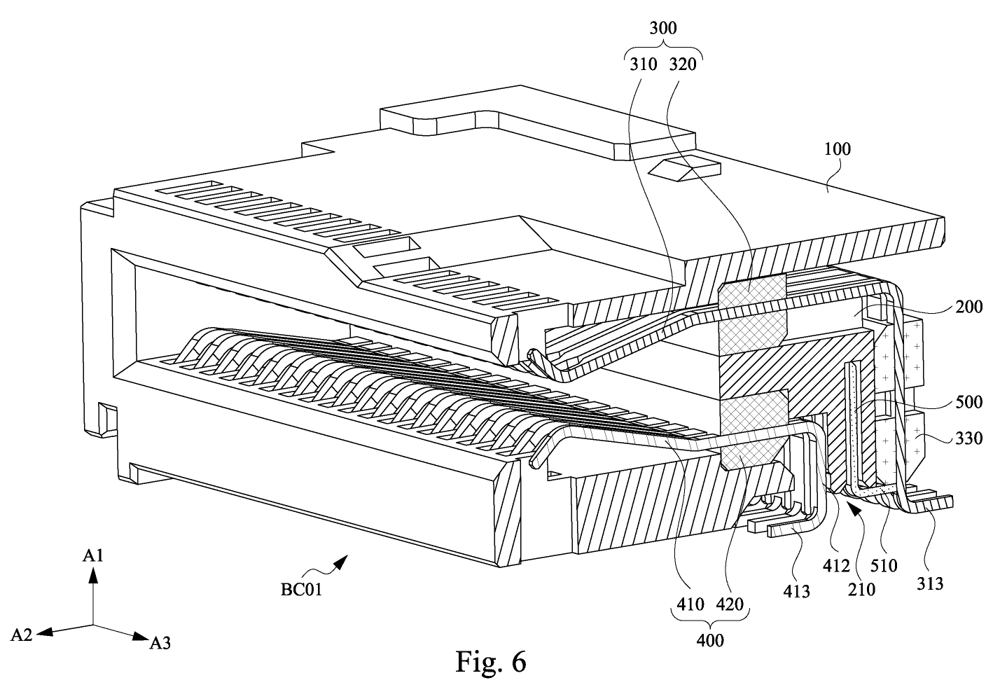

Please refer to FIG. 6. FIG. 6 is a cross-sectional view of partial components of the connector BC shown along the section line B-B' in FIG. 1. In some embodiments, the first terminal set 300 and the second terminal set 400 are respectively disposed on opposite sides of the insulating base 200. Specifically, the first terminal set 300 connects to the first surface 220 of the insulating base 200 via the first contact surface 321 of the first insulating module 320, and is secured by engaging the first engaging structure 340 into the through-hole 260 (shown in FIGS. 3A and 5A). The second terminal set 400 connects to the second surface 230 of the insulating base 200 via the second contact surface 421 of the second insulating module 420, and is secured by engaging the second engaging structure 440 into the through-hole 260 (shown in FIGS. 3A and 5B).

In FIG. 6, the first terminal set 300 contacts the third surface 290 of the insulating base 200 via the third insulating module 330, and the second terminal set 400 abuts against the abutting surface 240 of the insulating base 200 via the middle end 412 of the second terminal 410 (shown in FIG. 3A). Consequently, even if the first terminal 310 and the second terminal 410 are not straight, the first terminal set 300 and the second terminal set 400 remain positioned on opposite sides of the insulating base 200. The rear ends 313 of the first terminal 310 and the rear ends 413 of the second terminal 410 are located near the insertion slot 210.

In some embodiments, the shielding element 500 is installed in the insertion slot 210 and is secured by engagement with engaging ribs 2101, 2102, and 2101-1 within the insertion slot 210. Through the aforementioned design of the insertion slot, engaging ribs, and the like, the shielding element 500 may be easily installed in the insulating base 200 and positioned between the first terminal set 300 and the second terminal set 400 without the need for additional fastening tools or components.

When high-speed signals are transmitted through the adjacent first terminal set 300 and second terminal set 400, an interaction between electric and magnetic fields occurs between them. The interaction is known as near-field coupling. This coupling causes signal energy from one terminal to leak into the adjacent terminal, resulting in crosstalk. To suppress crosstalk between terminals, the shielding element 500 is positioned between the adjacent first terminal set 300 and second terminal set 400. By blocking the coupling paths of electric and magnetic fields, electromagnetic interference between terminals is reduced, thereby improving signal integrity and the overall performance of the connector.

In some embodiments, the shielding element 500 is a metal shielding plate having a contact end 510 that electrically contacts the rear end 313 of the first terminal 310. The contact end 510 of the shielding element 500 is configured to electrically contact the ground terminal 3101 of the first terminal 310 (please refer to FIGS. 3B, 4B, and 5A in conjunction with the above description). In some embodiments, the shielding element 500 is configured to make electrical contact only with the first terminal 310.

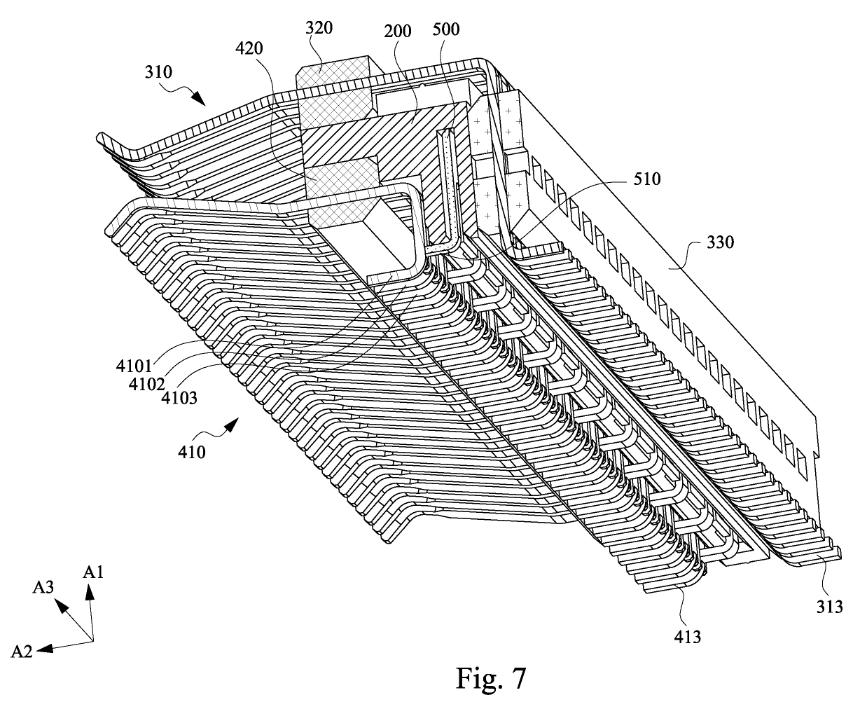

Please refer to FIG. 7. FIG. 7 is a schematic view of partial components of the connector BC of another embodiment. Unlike the embodiment shown in FIG. 6, the shielding element 500 may be configured to make electrical contact with the second terminal 410. Specifically, the contact end 510 of the shielding element 500 makes electrical contact with the ground terminal 4101 of the second terminal 410. In other embodiments, the shielding element 500 may be in electrical contact with both the first terminal 310 and the second terminal 410. In some embodiments, the shielding element 500 is configured to be in electrical contact only with the second terminal 410. In other embodiments, the shielding element 500 may be configured to be in electrical contact with both the first terminal 310 and the second terminal 410.

In summary, the connector of the present disclosure facilitates the quick and easy installation of the shielding element between two terminal sets by providing the insertion slot in the insulating base with the opening facing the printed circuit board. Furthermore, since the shielding element of the connector of the present disclosure contacts only one of the terminal sets on a single side, it simplifies the assembly process and reduces the production cost of the shielding element while meeting standard shielding specifications.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present disclosure cover modifications and variations of this present disclosure provided they fall within the scope of the following claims.

What is claimed is:

1. A connector for installation on a printed circuit board, comprising:
a housing;
an insulating base mounted within the housing and comprising an insertion slot facing the printed circuit board;
two terminal sets mounted within the housing and respectively positioned on opposite sides of the insulating base; and
a shielding element mounted within the insertion slot, the shielding element having a contact end configured to make electrical contact with at least one of the two terminal sets.

2. The connector of claim 1, wherein each of the two terminal sets comprises at least one terminal having a rear end adjacent to the insertion slot, wherein the contact end of the shielding element contacted the rear end, and the at least one terminal comprises a ground terminal.

3. The connector of claim 1, wherein each of the two terminal sets comprises at least one terminal and an insulating module.

4. The connector of claim 1, wherein the insertion slot of the insulating base has opposite two inner side walls, and the insulating base comprises at least two engaging ribs located within the insertion slot and respectively disposed on the two inner side walls.

5. The connector of claim 4, wherein the at least two engaging ribs are positioned on the two inner side walls in a mutually opposed manner.

6. The connector of claim 1, wherein the insertion slot of the insulating base has an inner side wall, and the insulating base comprises at least one engaging rib located within the insertion slot and disposed on the inner side wall.

7. The connector of claim 1, wherein the insulating base has a first surface, a second surface opposite the first surface, and at least one through-hole extending through the first surface and the second surface, wherein each of the two terminal sets comprises an insulating module having a contact surface contacting the first surface or the second surface, and an engaging structure located on the contact surface and configured to fit into the at least one through-hole.

8. The connector of claim 7, wherein the engaging structure comprises a body and at least one engaging flange located on an outer periphery of the body.

9. The connector of claim 1, wherein the insulating base has an abutting surface facing one of the two terminal sets and a plurality of abutting ribs arranged in parallel on the abutting surface.

10. The connector of claim 1, wherein the insulating base has an abutting surface facing one of the two terminal sets and an abutting rib located on the abutting surface.

11. A connector for installation on a printed circuit board, comprising:
a housing;
an insulating base mounted within the housing and comprising an insertion slot, wherein the insertion slot has an opening facing the printed circuit board;
two terminal sets mounted within the housing and respectively positioned on opposite sides of the insulating base; and
a shielding element mounted within the insertion slot, the shielding element having a contact end configured to make electrical contact with one of the two terminal sets.

12. The connector of claim 11, wherein the one of the two terminal sets comprises at least one terminal having a rear end adjacent to the insertion slot, wherein the contact end of the shielding element contacted the rear end, and the at least one terminal comprises a ground terminal.

13. The connector of claim 11, wherein the one of the two terminal sets comprises at least one terminal and an insulating module.

14. The connector of claim 11, wherein the insertion slot of the insulating base has opposite two inner side walls, and the insulating base comprises at least two engaging ribs located within the insertion slot and respectively disposed on the two inner side walls.

15. The connector of claim 14, wherein the at least two engaging ribs are positioned on the two inner side walls in a mutually opposed manner.

16. The connector of claim 11, wherein the insertion slot of the insulating base has an inner side wall, and the insulating base comprises at least one engaging rib located within the insertion slot and disposed on the inner side wall.

17. The connector of claim 11, wherein the insulating base has a first surface, a second surface opposite the first surface, and at least one through-hole extending through the first surface and the second surface, wherein each of the two terminal sets comprises an insulating module having a contact surface contacting the first surface or the second surface, and an engaging structure located on the contact surface and configured to fit into the at least one through-hole.

18. The connector of claim 17, wherein the engaging structure comprises a body and at least one engaging flange located on an outer periphery of the body.

19. The connector of claim 11, wherein the insulating base has an abutting surface facing one of the two terminal sets and a plurality of abutting ribs arranged in parallel on the abutting surface.

20. The connector of claim 11, wherein the insulating base has an abutting surface facing one of the two terminal sets and an abutting rib located on the abutting surface.
